(19) United States
(12) Patent Application Publication
(10) Pub. No.: US 2026/0095792 A1
(43) Pub. Date: Apr. 2, 2026

(54) METHODS FOR TRIGGERING AIOT PROXIMITY DETECTION

(71) Applicant: InterDigital Patent Holdings, Inc., Wilmington, DE (US)

(72) Inventors: Aata El Hamss, Laval (CA); Martino Freda, Laval (CA); Erdem Bala, East Meadow, NY (US); Paul Marinier, Brossard (CA); Ahmed Mostafa, Ottawa (CA); Moon IL Lee, Melville, NY (US); Remun Koirala, London (GB)

(73) Assignee: InterDigital Patent Holdings, Inc., Wilmington, DE (US)

(21) Appl. No.: 18/902,596

(22) Filed: Sep. 30, 2024

(51) Int. Cl. H04W 24/10; H04W 4/02; H04W 4/80; H04W 52/18; H04W 72/044

(52) U.S. Cl. CPC H04W 24/10; H04W 52/18; H04W 72/0473; H04W 4/02; H04W 4/80

(57) ABSTRACT

A method performed by a reader may comprise: receiving configuration information, wherein the configuration information includes one or more proximity detection levels to perform a proximity detection procedure, a list of one or more device IDs for proximity detection, and one or more transmit powers for a proximity detection procedure; performing a proximity detection procedure for one or more proximity detection levels; and transmitting, to a network, a report including a number of detected devices.

### BACKGROUND

Internet of Things (IoT) systems typically include connected devices (e.g., sensors) that communicate with a network using small data payloads and low transmission power. The types of devices and deployment scenarios continue to evolve as the demand for connected technologies grows. Ultra-low power consumption IoT devices for cellular systems have garnered significant interest. Accordingly, some wireless standards organizations, including the 3rd Generation Partnership Project (3GPP), are evaluating how Ambient IoT (AIoT) devices can be deployed and supported in cellular networks.

### SUMMARY

A method performed by a reader may comprise: receiving configuration information, wherein the configuration information includes one or more proximity detection levels to perform a proximity detection procedure, a list of one or more device IDs for proximity detection, and one or more transmit powers for a proximity detection procedure; performing a proximity detection procedure for one or more proximity detection levels; and transmitting, to a network, a report including a number of detected devices. The reader may be one of a WTRU, a base station, or an IAB. The performance of the proximity detection procedure is initiated based on an indication from the network or may be autonomously initiated. The report may further include one or more IDs of the detected devices from the list of device IDs for proximity detection. The configuration information may further include a number of repetitions to be used for a proximity detection procedure.

The proximity detection procedure may include the reader: transmitting, to one or more devices, an R2D transmission via one of the one or more transmit powers; monitoring for device-to-reader (D2R) transmissions; and determining a number of devices located within a selected proximity level. The transmission of the R2D transmission may indicate: (1) a set of time resources to be used by the device for the D2R transmissions and/or (2) a set of frequency resources to be used by the device for the D2R transmissions.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example where an AIoT device communicates directly with a base station;

FIG. 3 is a system diagram illustrating an example where an AIoT device communicates with an intermediate node;

FIG. 4 is a system diagram illustrating an example where an AIoT device communicates with downlink assistance;

FIG. 5 is a system diagram illustrating an example where an AIoT device communicates with uplink assistance;

FIG. 6 illustrates an example of different D2R transmissions times using timing offsets; and

FIG. 7 is a flow chart illustrating an exemplary procedure performed by a WTRU.

### DETAILED DESCRIPTION

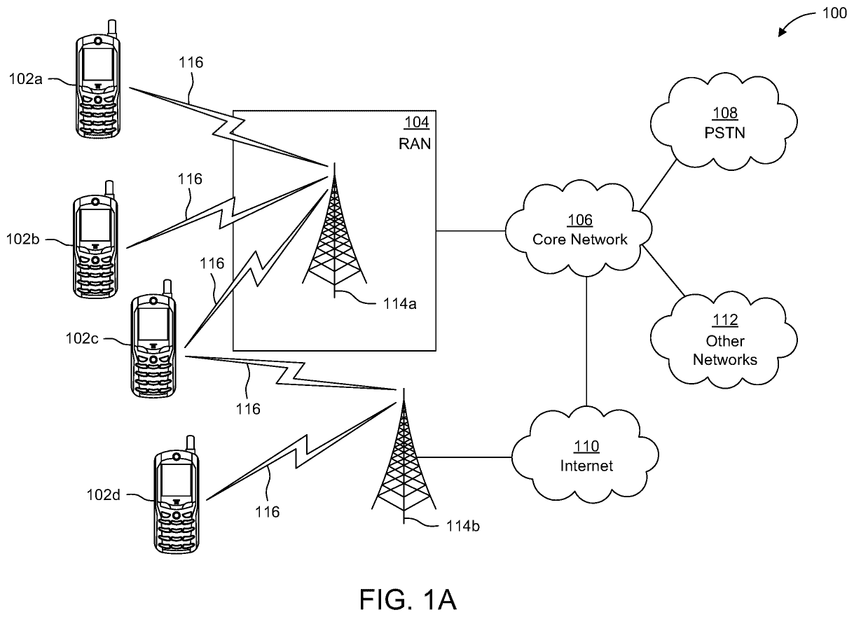

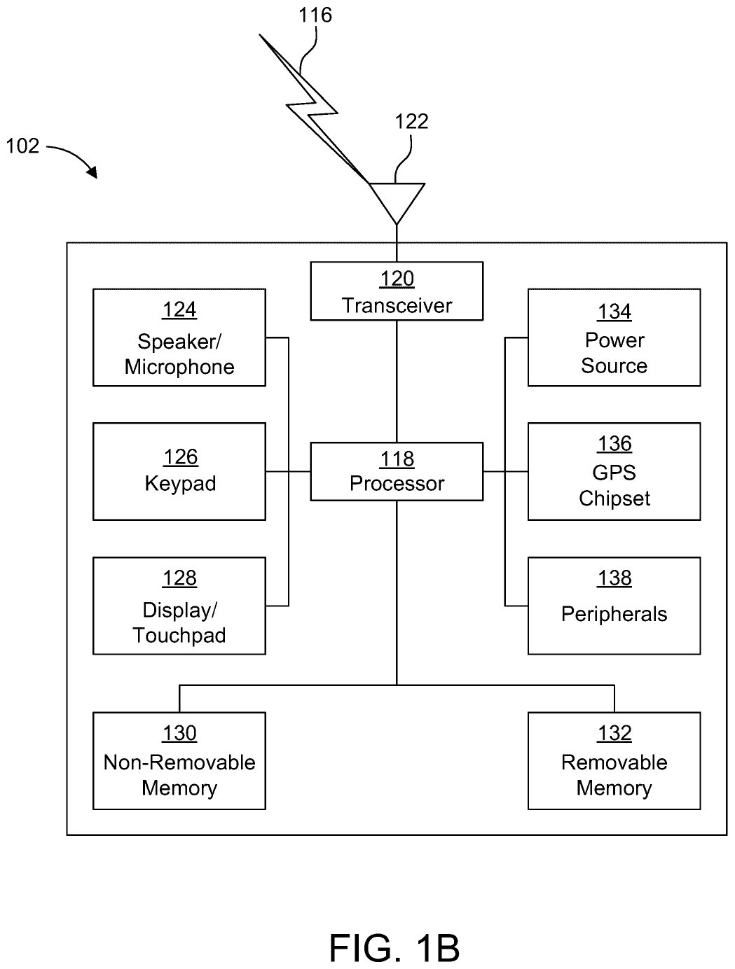

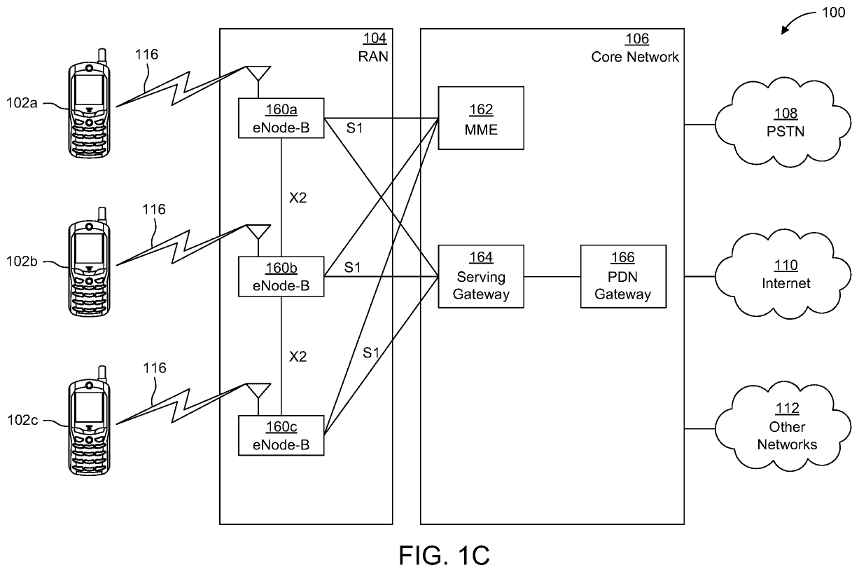

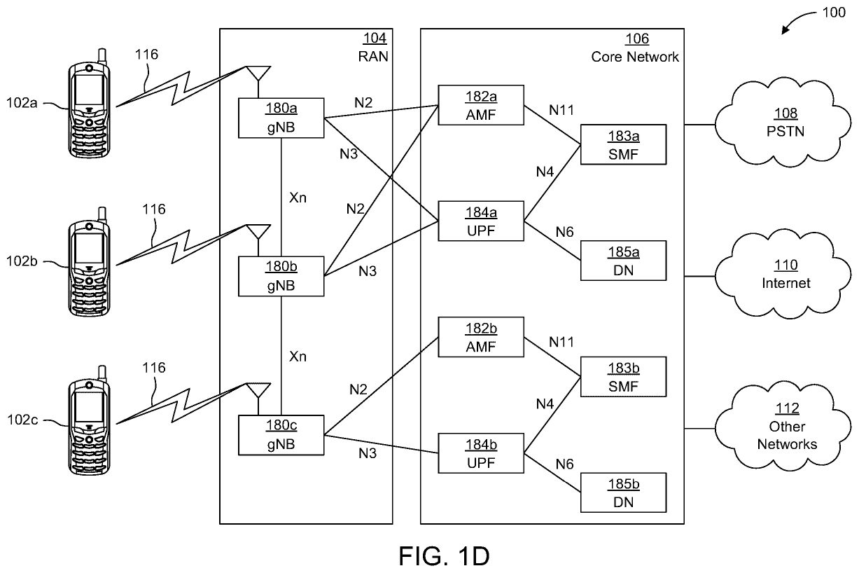

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:

| | |
|---|---|
| ACK | Acknowledgement |
| AIoT | Ambient IoT |
| BS | Base Station |
| BWP | Bandwidth Part |
| CQI | Channel Quality Indicator |
| CRC | Cyclic Redundancy Check |
| CSI | Channel State Information |
| D2R | Device-to-Reader |
| DCI | Downlink Control Information |
| DL | Downlink |
| DM-RS | Demodulation Reference Signal |
| DRB | Data Radio Bearer |
| HARQ | Hybrid Automatic Repeat Request |
| IAB | Integrated Access and Backhaul |
| IoT | Internet of Things |
| MAC | Media Access Control |
| MCS | Modulation and Coding Scheme |
| NACK | Negative ACK |
| NR | New Radio |
| OFDM | Orthogonal Frequency-Division Multiplexing |
| PHY | Physical Layer |
| PC | Paging Occasion |
| PRB | Physical Resource Block |
| R2D | Reader-to-Device |
| RB | Resource Block |
| RF | Radio Front end |
| RLF | Radio Link Failure |
| RLM | Radio Link Monitoring |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| SFO | Synchronization Frequency Offset |
| SRS | Sounding Reference Signal |
| SSB | Synchronization Signal Block |
| TB | Transport Block |
| TBS | Transport Block Size |
| Tc1 | Transmission Configuration 1 |
| TRP | Transmission/Reception Point |
| TSC | Time-sensitive communications |
| UE | User Equipment |
| UL | Uplink |
| URLLC | Ultra-Reliable and Low Latency Communications |
| WTRU | Wireless Transmit/Receive Unit |

A range of connected devices and sensors can be classified as AIoT devices. A first type of AIoT device may be capable of a peak power consumption around one micro watt and include energy storage. This first type of AIoT device may not be able to perform DL or UL amplification. The device's UL transmission may be achieved through backscattering on an externally provided carrier wave.

A second type of AIoT device may be capable of peak power consumption around few hundred micro watts and include energy storage. This second type of AIoT device may be capable of DL or UL amplification. The device's UL transmission may be achieved through backscattering on an externally provided carrier wave.

A third type of AIoT device may be capable of peak power consumption around few hundred micro watts and include energy storage. This third type of device may be capable of DL or UL amplification. The device's UL transmission may be generated internally by the device.

The first and the second type of AIoT devices described above may have poor synchronization performance, which may lead to high synchronization frequency offset (SFO). SFO may impact the transmission timing from a device to a reader. Furthermore, the first and second type of devices may require an energy harvester module to charge its battery. During high energy level, the device may be capable of longer transmission duration and/or more transmissions whereas in low energy level the device may not be capable to transmit. The third type of AIoT device described above may be more advanced, offering higher synchronization accuracy and greater energy capacity.

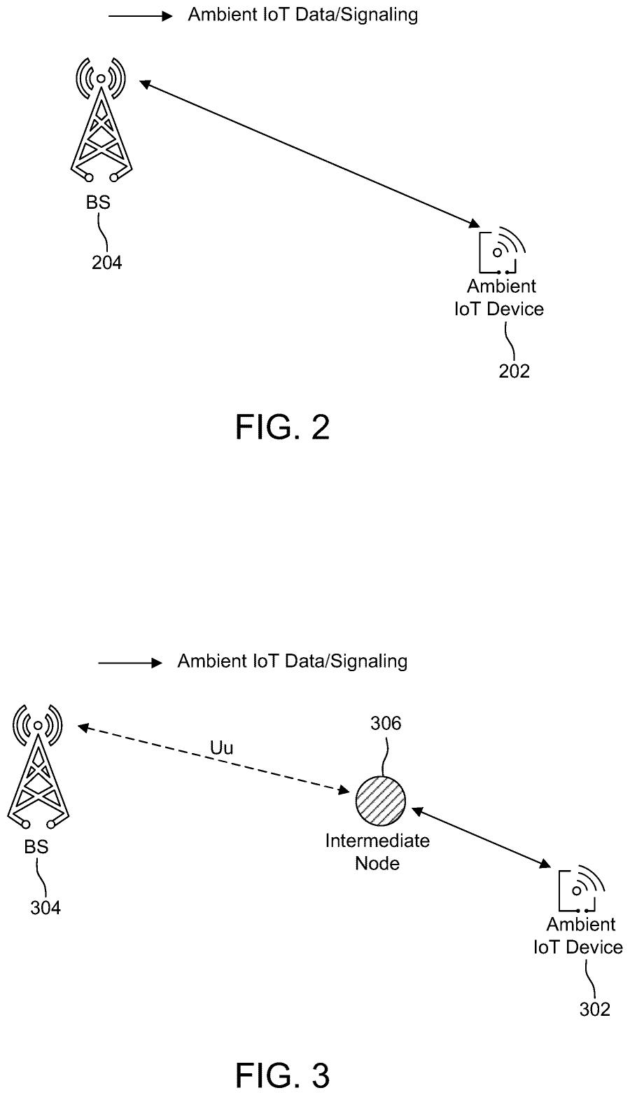

AIoT devices may be deployed in various topologies. In a first topology, an AIoT device may be able to communicate directly with the base station. FIG. 2 illustrates an exemplary system in which an AIoT device 202 communicates directly with a base station 204.

In a second topology, an AIoT device may communicate with an intermediate node that transfers the communication to the base station. Such intermediate node may be a WTRU, repeater, or an IAB node. FIG. 3 illustrates an exemplary system in which an AIoT device 302 communicates with an intermediate node 306. The intermediate node 306 then transfers the communication to a base station 304.

In a third topology, an AIoT device may transmit data/signaling to a base station, and receive data/signaling from an assisting node. Alternatively, the AIoT device may receive data/signaling from the base station and transmits data/signaling to the assisting node. The assisting node may be a relay, IAB, WTRU, or repeater with ambient IoT capabilities.

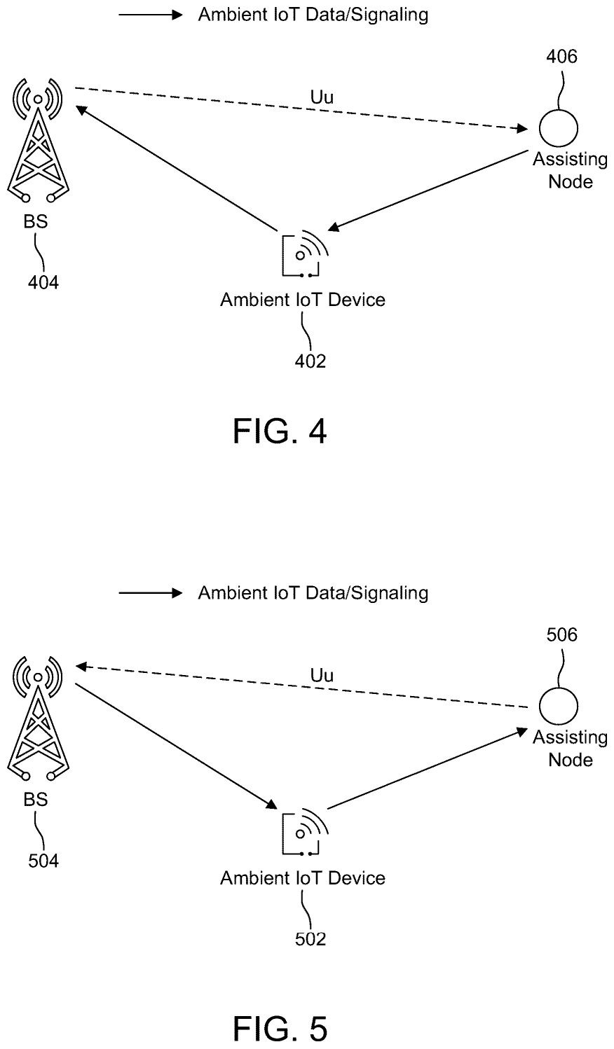

FIG. 4 illustrates an exemplary system in which an AIoT device receives downlink assistance. As shown in FIG. 4, an AIoT device 402 may transmit data/signaling to a base station 404 and receive data/signaling from an assisting node 406. FIG. 5 illustrates an exemplary system in which an AIoT device receives uplink assistance. As shown in FIG. 5, an AIoT device 502 may receive data/signaling from a base station 504 and then transmit data/signaling to an assisting node 506.

In the first topology described above (i.e., FIG. 2), the base station may be responsible for scheduling the AIoT device whereas for the second topology described above (i.e., FIG. 3), the intermediate WTRU may be responsible for scheduling the AIoT device. In the third topology described above (i.e., FIGS. 4 and 5), the scheduling may be either from the base station or the assisting node.

Proximity detection uses a reader to identify devices within a specified range, generating a list of devices based on their distance from the reader. The system may support multiple proximity levels to provide more precise distance measurements. Proximity detection helps the network assign a reader to transmit or receive data for a group of devices. It may also assist the network in locating specific readers, particularly when a device has a fixed, known location.

New Radio AIoT is designed for devices with extremely low energy consumption. These devices may only transmit when triggered by a transmission from a reader. This means the reader must initiate transmissions to the devices without knowing if any are nearby. Continuously sending R2D signals to detect the presence of devices could cause interference with other R2D channels and increase the power consumption of the reader.

A key challenge is how a reader can efficiently trigger device proximity detection across various distance and/or proximity levels. For example, challenges may include how the reader selects the appropriate proximity level for detection, how it configures transmission parameters for proximity detection, and when it should report the detection results to the network.

Hereinafter, the term “device” may refer to an AIoT device, an IoT device, a machine type communication (MTC) device, or a WTRU with reduced capability (e.g., reduced power capability). Hereinafter, the term “reader” may refer to a WTRU, base station, an IAB, a device acting as relay, and/or an intermediate WTRU acting as a relay between the base station and the device. A WTRU may refer to reader that is a WTRU acting as intermediate WTRU between the network and one or more devices.

A reader may be a base station or a WTRU under control or coverage of a base station. When the reader is a WTRU, it may receive configurations information related to and/or associated with AIoT operations from a base station or from another entity controlling AIoT operations (e.g., an AIoT controller). Such configurations information may be received by a physical layer, MAC layer, or higher-layer signaling (e.g., RRC or other protocol). Unless otherwise specified, any parameter or configuration utilized by a reader may be obtained using such signaling.

Hereinafter, a transmission from a D2R may be a transmission of data information, transmission of control information, or preamble/midamble/postamble/reference signal transmission. A D2R transmission may be transmitted following receiving a scheduling from a reader or alternatively initiated by the device. For example, a device may initiate a transmission for initial access.

A device may be pre-configured with one or more preamble/midamble/postamble/reference signal transmission parameters. A reader may indicate, to the device, which preamble to use for the transmission. Each preamble may be configured with different sequence.

Hereinafter, a transmission from a R2D may be a transmission of data information, transmission of control information, or preamble/midamble/postamble/reference signal transmission. A R2D transmission may be transmitted following receiving a scheduling from a reader.

The network may support different types of devices and each device type may have certain capabilities.

For example, a first type of AIoT device may be capable of a peak power consumption around one micro watt and include energy storage. This first type of device may not be capable of D2R or R2D transmission amplification. The D2R transmission may be achieved through backscattering on an externally provided carrier wave.

For example, a second type of AIoT device may be capable of peak power consumption around few hundred micro watts and includes energy storage. This second type of device may be capable of D2R or R2D transmission amplification. The D2R transmission may be achieved through backscattering on an externally provided carrier wave.

For example, a third type of AIoT device may be capable of peak power consumption in a third power range, and include energy storage. This third type of device may be capable of D2R or R2D transmission amplification. The D2R transmission may generated internally by the device.

Hereinafter, the term “time unit” may refer to a pre-defined duration in terms of an absolute unit of time such as a second, millisecond and the like. Alternatively, a “time unit” may refer to a pre-defined duration in terms of a certain number of symbols, slots or frames. Alternatively, a “time unit” may refer to a time period indicated dynamically by a transmission such as a synchronization signal, sync transmission, preamble, midamble, or postamble transmission.

AIoT commands may be a control or data transmissions from an R2D requesting the report of some information from the device. The requested information may then be transmitted by the device following the reception of the AIoT command. The AIoT command may be transmitted in R2D control channel or R2D data channel. In one example, the AIoT command may be a request to a device to identify itself. Following such command the device may report its device identity (device ID) to the reader. In another example, the AIoT command may be a request to report a collected information from the device. This information may be, for example, collected from the surrounding environment using sensors (e.g., measure temperature). In another example, the AIoT command may be a request to report the device duty cycle related information. The duty cycle information may include at least one or more of: on-duration, off duration, activity cycle, maximum on-duration and maximum duty cycle. The AIoT command may be a request to report the energy level of the device.

An inventory procedure may include determining the identity of devices near the reader. The inventory procedure may be performed in multiple steps to resolve any contention from multiple devices trying to transmit inventory command response.

A proximity detection procedure may involve a reader detecting the presence of one or more devices nearby. To initiate this process, the reader may begin an R2D transmission, which prompts nearby devices to respond with a D2R transmission. A device that detects the R2D transmission may be configured to reply (i.e., send a D2R transmission) if the received power of the R2D signal exceeds a certain threshold. Alternatively, a device may respond if it successfully decodes the R2D transmission.

Upon receiving a D2R transmission in response to an R2D transmission for proximity detection, the reader may be configured to do one or both of the following: consider a device to be in proximity if it successfully decodes the D2R transmission, or consider a device to be in proximity if the measured power of the D2R transmission exceeds a set threshold.

A proximity detection level may include a reader detecting one or more devices in proximity within a certain range. Each range may be associated with a received power threshold. The reader may be configured with multiple received power thresholds where each threshold is associated with a proximity detection level. When measuring the received power of a D2R transmission, the reader may determine that a device is in a proximity level if the measured power is above the corresponding received power threshold for that proximity level. The reader may consider a device in a proximity if the reader measures the received power of D2R transmission from the device and the measured power is above a threshold and successfully decodes the D2R transmission. The reader may be configured to successfully decodes a D2R transmission from a device and then measure the received power of D2R transmission to determine whether a device is in proximity.

The proximity detection procedure differs from inventory procedures in only determining the presence of devices nearby without necessarily identifying the device ID. Although in some solutions, proximity detection procedure may result in a reader determining the device ID of the devices in proximity of the reader. For example, the reader may determine the device ID by decoding the D2R transmission or detecting a sequence associated with the device ID. Alternatively, the reader may determine the presence of a device in proximity without knowing the device ID.

A reader may be configured with a set of proximity detection levels to perform proximity detection procedures. The reader may receive such configuration information from the base station using RRC signaling or alternatively, from an AIoT core network (e.g., AIoT server). The reader may be configured with a set of received D2R power thresholds, with each threshold corresponding to a proximity detection level. To detect devices within a proximity detection level, the reader may measure the received power of a D2R transmission and compare it with the received D2R power threshold corresponding to that proximity detection level. If the measured received power is above that threshold, the reader may determine that the device is within the proximity detection level.

A reader may be configured with a list of device IDs for proximity detection procedures. The reader may report, to the network, (e.g., AIoT server or base station) the presence of one or more device IDs when the reader detects their presence in proximity. The reader may be configured using higher layer signaling with the list of device IDs. The configured device IDs may belong to device with fixed and known location to the network. When detecting the presence and reporting the presence of the configured list of IDs, the network may determine the location/position of the reader and track the reader movement.

A reader may be configured with a set of transmit power for R2D transmissions and/or number of repetitions for R2D transmission. Such configuration of transmit power and number of repetitions may be used by the reader to initiate proximity detection for devices nearby the reader (i.e., power transmission/number of repetitions of R2D initiating proximity detection). In an embodiment, the reader may be configured with a set of R2D transmit power and a set of R2D repetitions number to initiate proximity detection, where each R2D transmit power and R2D repetition number is associated with a proximity detection level.

For example, the reader may be configured with a two R2D transmission powers, where a first R2D transmission power is associated with a first proximity detection level and a second R2D transmission power is associated with a second proximity detection level. In another example, the reader may be configured by two R2D repetition numbers (e.g., 2 and 4 repetitions), where the first R2D repetition number is associated with a first proximity detection level and the second R2D repetition number is associated with a second proximity detection level. The R2D transmit power, and the number of repetitions may be configured by the base station using RRC signaling or higher layer signaling from the core network.

The reader may be configured with a received power thresholds for D2R transmission replying to R2D transmission initiating proximity detection. Such configuration of received power threshold may be used by the reader to determine whether a device is within proximity of the reader. The reader may be configured with a set of received power thresholds for D2R transmission, where each received power thresholds is associated with a proximity detection level. The received power thresholds for D2R transmission may be configured by the base station using RRC signaling or higher layer signaling from core network.

The reader may be configured by the network with frequency resource on which the reader should perform proximity detection procedures. The configured frequency resource may be used by the reader to transmit R2D transmission that trigger potential devices to transmit D2R transmission for proximity detection procedure. In one example solution, the reader may be configured with multiple frequency resources and the reader selects one of the frequency resources to use for proximity detection procedure. The reader may select a frequency resource to use for proximity detection based on the carrier wave configuration. For example, the reader may be configured with multiple frequency resource to use for proximity detection and each one is associated with a carrier wave configuration. The reader may determine which carrier wave is being used by the network and may then select the frequency resource to transmit R2D according to the association. Multiple carrier waves may be used by the network and the reader may select the carrier wave that is used by the closest carrier wave transmitter. The reader may determine the closest carrier wave transmitter by measuring transmissions from the carrier wave transmitters and selecting the transmitter with the highest received power.

The reader may be configured, by the network, with a device type for which the proximity detection procedure is intended for. The reader may determine the proximity detection method based on the device type for which the proximity detection procedure is targeted. For example, the reader may be configured to perform proximity detection procedure for only one device type. Alternatively, the reader may be configured to perform proximity detection for multiple device types.

The device type configuration may include the transmit power capability of the devices. For example, the device type configuration may include a maximum transmit power that the device is capable of. The reader may then determine the received power threshold for determining whether a device is in proximity or not using the transmit power capability of the device.

In one example configuration, as shown in Table 1 below, the reader may be configured with three proximity levels for proximity detection, where each proximity level is associated with a transmit power for R2D transmission, a number of repetitions, and a received power threshold and list of device IDs.

TABLE 1
Example Configurations of Proximity Level Procedures

| | | | Received | |
|---|---|---|---|---|
| Proximity | Transmit | Number of | Power | |
| Level | Power | Repetitions | Threshold | Device IDs |
| PL1 | P_{tx, 1} | N₁ | P_{rx, th1} | {ID_{1, 1}, ID_{1, 2}, . . . |
| | | | | ID_{1, x}} |
| PL2 | P_{tx, 2} | N₂ | P_{rx, th2} | {ID_{2, 1}, ID_{2, 2}, . . . |
| | | | | ID_{2, x}} |
| PL3 | P_{tx, 3} | N₃ | P_{rx, th3} | {ID_{3, 1}, ID_{3, 2}, . . . |
| | | | | ID_{3, x}} |

A reader may be configured to receive an explicit indication from the network to start proximity detection procedure. For example, the reader may receive an indication from the AIoT server to start proximity detection procedure. In another example, the base station may configure the reader to start proximity detection procedure. The reader may be configured with periodic time opportunity to perform the proximity detection procedure. Such configuration may include a slot number(s) (e.g., frame number and offset) and periodicity. For example, a time pattern within a frame when the reader should initiate the proximity detection procedure. The time pattern may be configured with a periodicity that repeats the configured time pattern. Multiple time patterns and periodicity may be configured to the reader, where each time pattern and periodicity may be associated with a proximity level.

A reader may be configured to semi-persistently perform the proximity detection procedure. For example, the reader may be configured with periodic time opportunity to perform the proximity detection procedure and only initiate proximity detection procedure after receiving an indication to start. The reader may stop a proximity detection procedure after receiving an indication to stop.

A reader may be configured to autonomously initiate the proximity detection procedures. The reader may be configured with a set of triggers to initiate proximity detection procedures. The reader may be configured with one or combination of triggers to initiate the proximity detection procedure.

A reader may be configured to initiate the proximity detection procedure based on initiating or completing handover procedures. When the reader initiates and/or complete the handover procedure, it starts proximity detection procedure to detect the presence/number of devices in proximity. For example, when the reader receives a handover command, the reader may start the proximity detection procedures. In another example, the reader, after completing handover, may start proximity detection.

A reader may be configured to initiate the proximity detection procedure based on measurement results of reference signals. The reader maybe configured to measure reference signals and based on the measurement result determines whether to initiate proximity detection procedures. The reference signals may be SSB, CSI-RS or DM-RS of a serving cell or another cell.

A reader may be configured to initiate a proximity detection procedure if the reference signal measurement is above a configured threshold. For example, the reader may be configured to initiate a proximity detection procedure when the SSB measurements is above a threshold. This example may be used when the reader in a good coverage area with a reliable Uu link with the base station. Furthermore, this configuration may prevent the reader from initiating proximity detection when it moves out of cell coverage.

A reader may be configured to initiate a proximity detection procedure if the reference signal measurement is below a configured threshold. For example, the reader may be configured to initiate the proximity detection procedure when the SSB measurements is below the threshold. This configuration may be used when some devices are at the cell edge, and the network wants to assign a reader that is also at the cell edge.

A reader may be configured to initiate a proximity detection procedure based on initiating other R2D/D2R transmissions. For example, the reader may be configured to start a proximity detection procedure before initiating an inventory procedure. The reader performs proximity detection to determine how many devices are in proximity in order to assign D2R resources for inventory procedure according to the number of devices. In another example, the reader, during the inventory procedure, may determine the devices that are in proximity using the D2R transmissions received in response of inventory procedures. In another example, the reader may initiate an proximity detection procedure after sending AIoT commands to devices.

A reader may be configured to initiate a proximity detection procedure based on the number of devices responded during inventory procedures. The reader may initiate the proximity detection procedures after initiating the inventory procedure and receiving responses from devices and determining that the number of devices replied to inventory is below a configured number. For example, the reader may be configured to initiate proximity detection procedures after an absence of device responses during inventory procedures.

A reader may be configured to initiate a proximity detection procedure based on the last time a proximity detection procedure was performed. The reader may be configured to initiate a proximity detection procedure after a configured period from the last time proximity detection was performed. For example, the reader may start a timer when it initiates a proximity detection procedure. After the timer expires, the reader may initiate another proximity detection procedure. The reader set the timer value to the configured period from the last time proximity detection was performed. Such a period may be configured to the reader using higher layer signaling (e.g., using RRC signaling or signaling from an AIoT server).

A reader may be configured to initiate the proximity detection procedure based on an indication from the network that an external source is transmitting a carrier wave for AIoT devices. For example, the reader may receive an indication from the network that an external source is enabled to transmit carrier wave for D2R transmissions. The reader may then initiate a proximity detection procedure.

A reader may be configured to initiate the proximity detection procedure based on the configuration of uplink resources for proximity detection reporting. For example, a reader may be an intermediate WTRU that is scheduled by the base station. The base station may configure the reader WTRU with uplink resource and indicate that the uplink resource is for proximity detection result reporting. The reader WTRU may then start a proximity detection procedure.

A reader may be configured to initiate the proximity detection procedure after a re-configuration of the proximity detection configuration. For example, when the reader receives a new configuration of proximity detection procedures from the network, the reader may trigger proximity detection procedures.

A reader may be configured to initiate the proximity detection procedure based on the power saving state of the reader. For example, the reader may be configured to trigger proximity detection procedures when the reader is not in a power saving state.

A reader may be instructed to initiate a proximity detection procedure from another reader. For example, a reader may be configured to support sidelink transmissions. The reader may receive an indication to initiate a proximity detection procedure using sidelink control information and/or sidelink data transmission. The reader may receive an indication to initiate proximity detection for a proximity level and using an indicated transmit power and/or number of repetitions and/or a received power threshold for measurements. The reader may be indicated with proximity detection methods to use for proximity detection procedures (e.g., measurements method or decoding method).

A reader may be configured to select the proximity detection method to use for a proximity detection procedure. For example, a first method may be that the reader consider a device in a proximity if the reader can successfully decode D2R transmission from the device. A second method may be that the reader considers a device in a proximity if the reader performs a measurement on the D2R channel and the measured quantity is above a threshold. For example, the reader may measure the received power of D2R transmission from the device and the measured power is above a threshold. The reader may be configured to use one or a combination of proximity detection methods based on one or more of the following:

A reader may be configured to use one or a combination of proximity detection methods based on the device type that the reader is configured to target in a proximity detection procedure. For example, the reader may be configured to initiate proximity detection for device type that is not capable of generating its own transmission (i.e., relying on carrier wave from external source). The reader may select measurement methods for proximity detection (i.e., relying only on measurements of D2R transmission to determine the presence/absence of devices).

A reader can be configured to use one or more (or a combination) proximity detection methods based on the capability of the reader. For example, if a reader is with limited capability, the reader may select a decoding method (i.e., the reader uses only decoding of D2R transmission) to determine whether a device is in proximity or not.

A reader can be configured to use one or more (or a combination) proximity detection methods based on the power saving state of the reader. For example, if a reader is in power limited state, the reader may select measurement methods for proximity detection (i.e., relying only on measurements of D2R transmission to determine the presence/absence of devices).

A reader may determine that a device is in proximity if the reader is able to successfully receive a D2R transmission from the device where the D2R transmission parameters belong to a specific set of parameters. For example, the reader may determine that a device is in proximity only if the chip duration of a successfully received D2R transmission is Tc1. The parameters may include one or more of the following: payload size in R2D transmission (e.g., number of bits), CRC length, channel coding type and rate, chip duration, signal amplification gain, modulation type (e.g., OOK or BPSK), data rate, etc. In one method, the reader may indicate to the devices the set of parameters (e.g., in a paging message or a proximity detection setup message) and the devices may use these parameters when proximity detection is triggered.

In an example of combining two proximity detection methods, a reader may first decode the received D2R transmission from a device (D2R transmission in response of initiating proximity detection procedure). If the reader can decode the transmission, then it may measure the received power of the D2R transmission. If the received power is above a configured threshold, the reader may determine that the device is in proximity.

In another example of combining two proximity detection methods, a reader may first measure the received power of D2R transmission from a device. If the measured power is above a configured threshold, the reader may then attempt to decode the D2R transmission. If the reader decodes the D2R transmission, the reader may determine that the device is in proximity.

A reader may be configured to transmit AIoT commands to initiate proximity detection procedures. The AIoT command may be carried in an R2D transmission. The AIoT command may be multiplexed with other AIoT transmission (e.g., multiplexed with synchronization signal to help the devices correct/synchronize with the reader). The AIoT proximity detection command may indicate the time and/or frequency for D2R transmission. The D2R transmissions may be overlapping in time and/or frequency. In one example, the reader may indicate to devices to start D2R transmission with different offset in time and/or frequency. The device may randomly select an offset when transmitting.

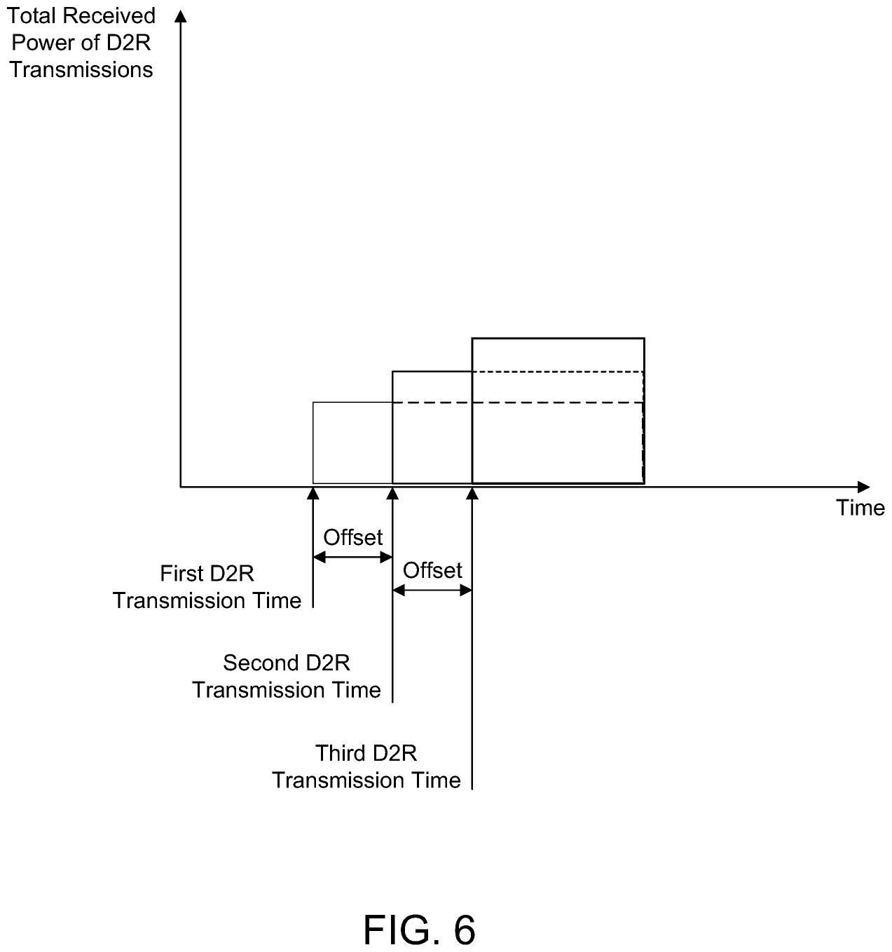

FIG. 6 illustrates different D2R transmission times using offsets. As shown in FIG. 6, three devices may use different transmission times by applying a time offset. The reader may use the increased power level in the received power of D2R transmissions to determine the number of devices in its proximity.

In one embodiment, a reader may be configured to perform proximity detection for multiple proximity detection levels using a multi-step approach. The reader may start detecting the presence of devices within a first proximity level (e.g., the lowest proximity level that the reader is configured with). After completing the proximity detection procedures with a first proximity detection level, the reader may detect the presence of devices within a second proximity level (e.g., the second lowest proximity level that the reader is configured with).

In one example of a multi-step approach to determine the proximity level for multiple proximity levels, a reader may perform the following steps for all the requested proximity levels, starting from the lowest proximity level:

First, the reader may transmit an R2D transmission using the associated transmit power and/or the number of repetitions for the proximity level. The reader may indicate a set of time and frequency resources to be used by devices for D2R transmissions (e.g., number of time slots, and/or number of frequency resources and/or the number of sequences).

Next, the reader may monitor the D2R transmission(s) from one or multiple devices within the selected proximity level.

Next, the reader may determine the number of devices within the selected proximity level using the received power level associated with the selected proximity level. For example, the reader may be configured with received power threshold for the proximity level equals to Prx. The reader may determine that the number of devices is equal to N if the received power of D2R transmissions is greater than NxPrx and lower than (N+1)×Prx. In another example, the reader may be configured to count the number of D2R transmissions received after R2D transmissions. The D2R transmissions may be transmitted in different time units. When the reader indicates to devices to use different offsets in time and/or frequency, the reader may use the increased power level in the received power of D2R transmissions to determine the number of devices a proximity level. Then, the reader may remove the number of devices detected from previous proximity detection level.

In one embodiment, the reader may be configured to perform proximity detection for multiple proximity detection levels using single-step approach. For example, the reader may be configured to perform proximity detection using the parameters configured for the highest proximity level. When measuring the received power of each D2R transmission, the reader may determine the received power range and determine the proximity level associated with each D2R transmission.

In one embodiment, a device replying to proximity detection transmission (i.e., R2D transmission from a reader) may indicate, in the D2R transmission, the transmit power used in the D2R transmission. This information may help the reader determine the proximity level of the device.

A reader may be configured to report, to the network, the number of detected devices for each proximity level. The reader may be configured to receive an explicit indication from the network requesting a set of proximity levels to report to the network. For example, higher layer signaling may be used by the network to indicate to the reader to report the number of devices detected in a proximity level. The reader may be configured with periodic time opportunity to report the proximity detection results. Such configuration may include a slot number(s) (e.g., frame number and offset) and periodicity.

A reader may be configured to semi-persistently report the proximity detection results. For example, the reader may be configured with periodic time opportunity to report the proximity detection procedure and only report proximity detection procedure after receiving an indication to start reporting. The reader may stop reporting proximity detection after receiving an indication to stop reporting.

A reader can be set up to anonymously report the number of detected devices to the network during the proximity detection process. The reader may be configured to report the proximity detection procedure based on the number of detected devices being above a configured threshold. For example, after performing a proximity detection procedure and determining that the number of devices in a proximity level is above a configured threshold, the reader may report the proximity detection procedure results to the network.

The reader may be configured to report the proximity detection procedure based on the number of detected devices being below a configured threshold. For example, after performing proximity detection and determining that the number of devices in a proximity level is below a configured threshold, the reader may report the proximity detection procedure results to the network.

The reader may be configured to report the proximity detection procedure based on detection of devices from a pre-configured list of device IDs. For example, when at least one device from a pre-configured list of device IDs is detected in proximity, the reader may report the proximity detection procedure results to the network.

The reader may be configured to report the proximity detection procedure after initiating or completing handover procedures. When the reader initiates and/or complete the handover procedure, the reader may report the proximity detection procedure results to the network.

The reader may be configured to report the proximity detection procedure after re-configuration of the proximity detection configuration. For example, when the reader receives a new configuration of proximity detection procedures from the network, the reader may report the proximity detection procedure results to the network.

A reader may be configured to report the proximity detection procedure based on the power saving state of the reader. For example, the reader may be configured to report the proximity detection procedure result when the reader is not in power saving state.

A reader may be configured to report to the network the number of detected devices for each proximity level. The reader may indicate to the network the received power threshold used in proximity detection procedure for each level. The reader may indicate to the network the proximity detection time (i.e., when the proximity detection was performed). The reader may indicate to the network the device IDs detected in proximity detection procedure for each level.

In one embodiment, a reader may be pre-configured with a set of proximity detection levels to perform proximity detection procedures. The reader may also be pre-configured with a list of device IDs that may be reported if one of the device ID is detected in a proximity level. The reader may be configured with a set of transmit power and/or number of repetitions to transmit R2D transmission for proximity detection procedures. The reader may be configured to associate each proximity detection level with a transmit power and/or number of repetitions. The reader may be configured with a set of received power thresholds for D2R receptions for each proximity level.

The reader may start a proximity detection procedure for one or more proximity detection levels. In one example, the reader may start a proximity detection procedure based on an explicit indication from the network (e.g., an indication from AIoT server to start the proximity detection). The reader may be configured with periodic time opportunity to perform proximity detection. Such configuration may include a subset of proximity level(s) to detect devices.

In another example, the reader may start a proximity detection procedure based on an autonomous triggering of proximity detection. The autonomous triggering may be based on: initiating or completing handover procedures; measurement results of reference signals; initiating other R2D transmissions (e.g., initiating inventory procedures); and absence of device responses during inventory procedures; and/or the last time proximity detection was performed.

Next, the reader may, for all the requested proximity levels, starting from the lowest proximity level: (1) transmits an R2D transmission using the associated transmit power and/or the number of repetitions for the proximity level; (2) indicates a set of time and frequency resources to be used by devices for D2R transmissions e.g., number of time slots, and/or number of frequency resources and/or the number of sequences; (3) monitor the D2R transmission(s) from one or multiple devices within the selected proximity level; and (4) determine the number of devices within the selected proximity level using received power level associated with the selected proximity level.

Next, the reader may report, to the network, the number of detected devices and/or the devices, from a pre-configured list, the device IDs that were detected at each of the one or more proximity levels.

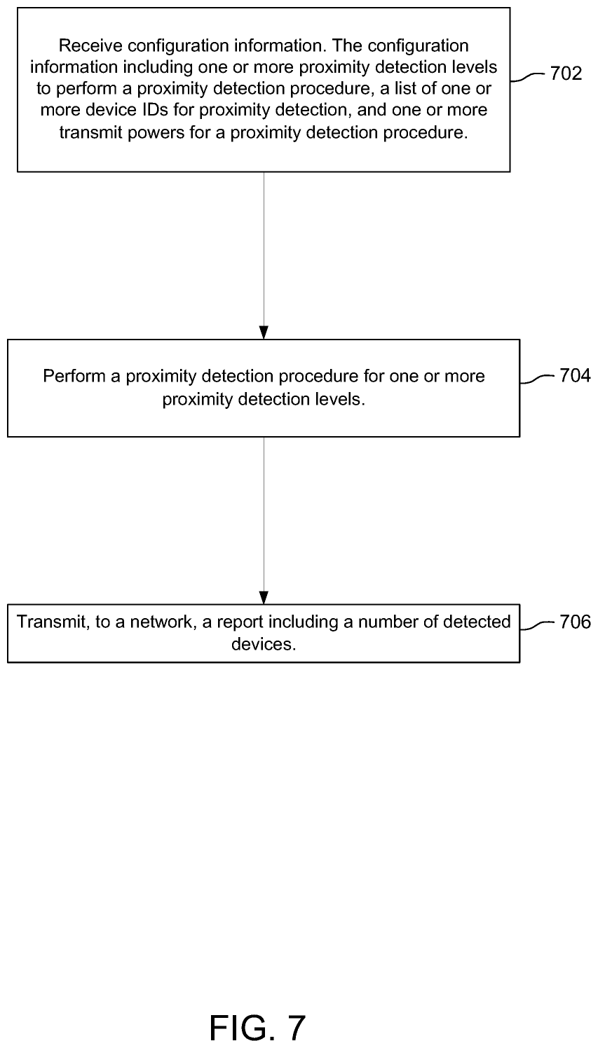

FIG. 7 illustrates an exemplary performed by a reader for triggering and reporting an AIoT proximity detection procedure. At 702, the reader may receive configuration information that includes one or more proximity detection levels to perform a proximity detection procedure, a list of one or more device IDs for proximity detection, and one or more transmit powers for a proximity detection procedure. At 704, the reader may perform a proximity detection procedure for one or more proximity detection levels. At 706, the reader may transmit, to a network, a report including a number of detected devices.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a reader, the method comprising:
receiving configuration information, wherein the configuration information includes one or more proximity detection levels to perform a proximity detection procedure, a list of one or more device IDs for proximity detection, and one or more transmit powers for a proximity detection procedure;
performing a proximity detection procedure for one or more proximity detection levels; and
transmitting, to a network, a report including a number of detected devices.

2. The method of claim 1, wherein the reader is one of a wireless transmit/receive unit (WTRU), a base station, or an integrated access and backhaul (IAB).

3. The method of claim 1, wherein the performance of the proximity detection procedure is initiated based on an indication from the network.

4. The method of claim 1, wherein the performance of the proximity detection procedure is autonomously initiated.

5. The method of claim 4, wherein the autonomous initiation is based on at least one of:
an initiation or completion of a handover;
a reference signal measurement;
an initiation of a reader-to-device (R2D) transmission; and
a last time a proximity detection procedure was performed.

6. The method of claim 1, wherein the proximity detection procedure includes the reader:
transmitting, to one or more devices, an R2D transmission via one of the one or more transmit powers;
monitoring for device-to-reader (D2R) transmissions; and
determining a number of devices located within a selected proximity level.

7. The method of claim 6, wherein the transmission of the R2D transmission indicates a set of time resources to be used by the device for the D2R transmissions.

8. The method of claim 7, wherein the transmission of the R2D transmission indicates a set of frequency resources to be used by the device for the D2R transmissions.

9. The method of claim 1, wherein the report further includes one or more IDs of the detected devices from the list of device IDs for proximity detection.

10. The method of claim 1, wherein the configuration information further includes a number of repetitions to be used for a proximity detection procedure.

11. A reader comprising:
a processor; and
a transceiver
wherein the processor and transceiver are configured to:
receive configuration information, wherein the configuration information includes one or more proximity detection levels to perform a proximity detection procedure, a list of one or more device IDs for proximity detection, and one or more transmit powers for a proximity detection procedure;
perform a proximity detection procedure for one or more proximity detection levels; and
transmit, to a network, a report including a number of detected devices.

12. The reader of claim 11, wherein the reader is one of a wireless transmit/receive unit (WTRU), a base station, or an integrated access and backhaul (IAB).

13. The reader of claim of claim 11, wherein the performance of the proximity detection procedure is initiated based on an indication from the network.

14. The reader of claim 11, wherein the performance of the proximity detection procedure is autonomously initiated.

15. The reader of claim 14, wherein the autonomous initiation is based on at least one of:
an initiation or completion of a handover;
a reference signal measurement;
an initiation of a reader-to-device (R2D) transmission; and
a last time a proximity detection procedure was performed.

16. The reader of claim 11, wherein the proximity detection procedure includes the reader:
transmitting, to one or more devices, an R2D transmission via one of the one or more transmit powers;
monitoring for device-to-reader (D2R) transmissions; and
determining a number of devices located within a selected proximity level.

17. The reader of claim 16, wherein the transmission of the R2D transmission indicates a set of time resources to be used by the device for the D2R transmissions.

18. The reader of claim 17, wherein the transmission of the R2D transmission indicates a set of frequency resources to be used by the device for the D2R transmissions.

19. The reader of claim 11, wherein the report further includes one or more IDs of the detected devices from the list of device IDs for proximity detection.

20. The reader of claim 11, wherein the configuration information further includes a number of repetitions to be used for a proximity detection procedure.
